(19) United States
(12) Patent Application Publication
(10) Pub. No.: US 2024/0086187 A1
(43) Pub. Date: Mar. 14, 2024

(54) Source Code Programming Language Prediction for a Text File

(71) Applicant: Crowdstrike, Inc., Sunnyvale, CA (US)

(72) Inventors: Ryan INGHILTERRA, Carlsbad, CA (US); Yung-Jin HU, Fremont, CA (US); Jayasankar DIVAKARLA, Kannamangala (IN); Jeffrey D. KAPLAN, Chagrin Falls, OH (US)

(21) Appl. No.: 17/943,061

(22) Filed: Sep. 12, 2022

(51) Int. Cl. G06F 8/75; G06F 21/56; G06N 3/04; G06N 3/08

(52) U.S. Cl. CPC G06F 8/75; G06F 21/566; G06N 3/0472; G06N 3/08

(57) ABSTRACT

A method to predict that a text file contains source code written in one or more of a plurality of source code programming languages involves creating a feature vector comprising a plurality of values, wherein each value represents a corresponding piece of text found in the text file. Then, during an inference workflow with a neural network model, embedding representation values identified for each value in the feature vector. An overall embedding representation value is calculated for the feature vector based on the obtained embedding representation values. A plurality of class label prediction values is then created, based on the overall embedding representation value and a plurality of class labels corresponding to the plurality of source code programming languages. Finally, a prediction is made as to the source code programming language in which the source code is written in the text file based on the plurality of class label prediction values.

### TECHNICAL FIELD

Embodiments of the present disclosure relate to digital computing systems, particularly with respect to predicting the source code programming language in which the text in a text file may be written.

### BACKGROUND

Digital security exploits that steal or destroy resources, data, and private information on computing devices are an increasing problem. Governments and businesses devote significant resources to preventing intrusions and thefts related to such digital security exploits. Some of the threats posed by security exploits are of such significance that they are described as cyber terrorism or industrial espionage.

Security threats come in many forms, including computer viruses, worms, trojan horses, spyware, keystroke loggers, adware, and rootkits. Such security threats may be delivered through a variety of mechanisms, such as spearfish emails, clickable links, documents, executables, or archives. Other types of security threats may be posed by malicious users who gain access to a computer system and attempt to access, modify, or delete information without authorization. With many of these threats, one or more text files containing malicious source code can be downloaded or otherwise installed on a computing device, or an existing one or more text files on the computing device can be modified to include malicious source code. Sometimes, the file names, file types, or file extensions of the files that contain source code, malicious or otherwise, may be modified so that it is not readily apparent what the files contains.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture of a distributed security system in which embodiments of the present disclosure may be used.

FIG. 2 illustrates a flowchart of a method to predict that a text file contains source code written in one or more of a plurality of source code programming languages according to example embodiments of the present disclosure.

FIG. 3 illustrates a flowchart of certain aspects of a method to predict that a text file contains source code written in one or more of a plurality of source code programming languages according to example embodiments of the present disclosure.

FIG. 4 illustrates a flowchart of certain aspects of a method to predict that a text file contains source code written in one or more of a plurality of source code programming languages according to example embodiments of the present disclosure.

FIG. 5 illustrates an example system architecture for a client device.

### DETAILED DESCRIPTION

Embodiments of the present disclosure can predict, detect, or classify programming language files in a constrained computing environment such as on a client computing device. For example, it is useful for data security purposes to, on the client computing device, quickly and accurately identify files that contain source code, and/or predict the programming language in which the source code is written, even if the file extensions or properties have been changed. Doing so enables a quick assessment of the type of programming language files being modified or moved to, from, or about the client system and the associated data loss risk. Embodiments of the present disclosure perform such prediction, detection, or classification on the client computing device, while maintaining a strict memory footprint and execution time constraints.

Current solutions for detecting files that contain source code written in a particular programming language, whether operating on the client computing device or otherwise, use rules-based approaches that differ for each programming language to be classified. These approaches have proven difficult and time consuming due to the manual work required to understand and craft different rules for each programming language. In addition, building rules for detecting each programming language becomes more challenging as more programming languages are added to the classification system and can lead to issues with multiple false positives for each inspected file. Machine learning provides an alternative approach by having a single model which can learn to classify multiple programming languages from a single pass on a file. However, machine learning solutions, especially those using deep learning-based architectures, come with challenges of their own. These models are generally built and used in interpreted languages such as Python, which require more memory to deploy for the inference workflow and are significantly slower, when compared to compiled languages such as C/C++ and Rust, making such solutions unworkable, if not untenable, for implementation on a client computing device.

As subsequently described, embodiments of the present disclosure enable machine learning model classification of programming languages in a constrained computing environment while avoiding the above noted problems with known solutions for programming language classification. Embodiments of the present disclosure can predict that a text file contains source code written in one or more source code programming languages. The embodiments do so by first creating a feature vector of values. Each value in the feature vector represents a corresponding piece of text found in the text file. Then, during an inference workflow with a neural network model, an embedding representation value is generated for each value in the feature vector. An overall embedding representation value is generated based on the embedding representation values corresponding to the values in the feature vector. The embodiments then create class label prediction values based on the overall embedding representation value and class labels corresponding to the source code programming languages. Finally, a prediction or classification is made regarding the source code programming language in which the source code is written in the text file based on the class label prediction values.

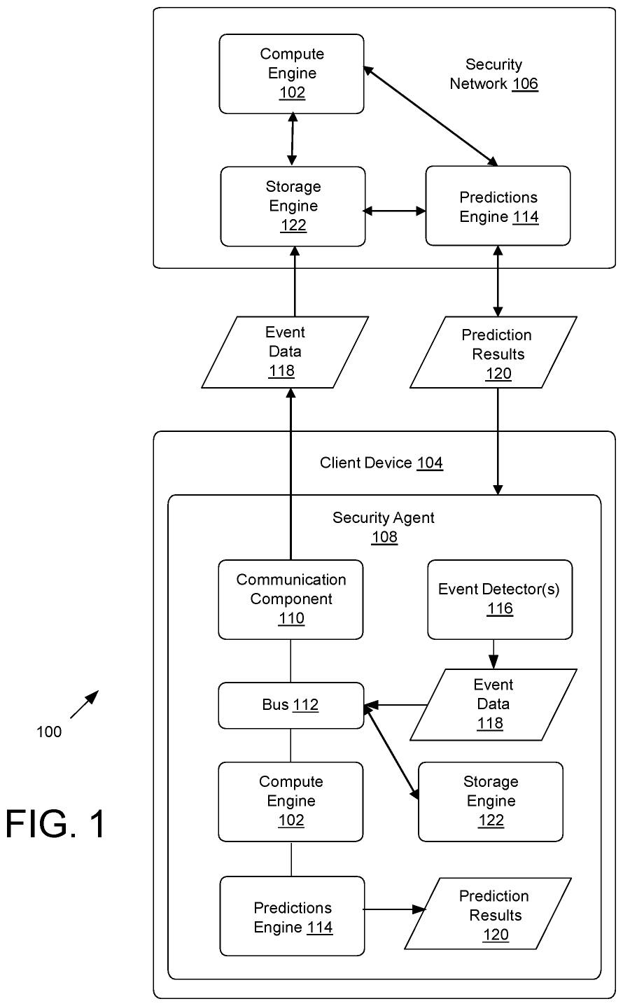

FIG. 1 depicts an example of a distributed security system 100 in which embodiments of the present disclosure may be deployed. The distributed security system 100 can include distributed instances of a compute engine 102 that can run locally on one or more client computing devices 104, or simply, client devices 104, and/or in a security network 106. As an example, some instances of the compute engine 102 can run locally on client devices 104 as part of security agents, or sensors, 108 executing on those client devices 104. As another example, other instances of the compute engine 102 can run remotely in a security network 106, for instance within a cloud computing environment associated with the distributed security system 100. The compute engine 102 can execute according to portable computer executable code that can run locally as part of a security agent 108, in a security network 106, and/or in other local or network systems that can also process event data as described herein.

Likewise, the distributed security system 100 can include distributed instances of a predictions engine 114 that can run locally on one or more client devices 104, and/or in a security network 106. As an example, some instances of the predictions engine 114 can run locally on client devices 104 as part of security agents 108 executing on those client devices 104. As another example, other instances of the predictions engine 114 can run remotely in a security network 106, for instance within a cloud computing environment associated with the distributed security system 100. The predictions engine 114 can execute according to portable computer executable code that can run locally as part of a security agent 108, in a security network 106, and/or in other local or network systems that can also process event data as described herein.

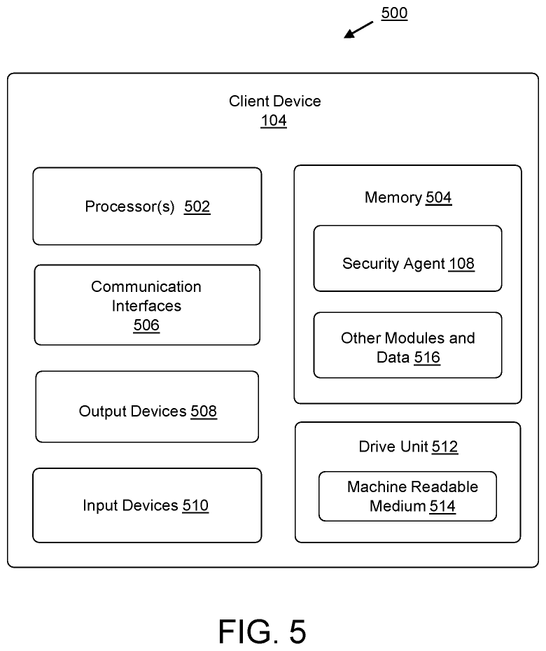

A client device 104 can include or be one or more computing devices. In various examples, a client device 104 can be a workstation, a personal computer (PC), a laptop computer, a tablet computer, a personal digital assistant (PDA), a cellular phone, a media center, an Internet of Things (IoT) device, a server or server farm, multiple distributed server farms, a mainframe, or any other sort of computing device or computing devices or combinations thereof. In some examples, a client device 104 can be a computing device, component, or system that is embedded or otherwise incorporated into another device or system. In some examples, the client device 104 can also be a standalone or embedded component that processes or monitors incoming and/or outgoing data communications. For example, the client device 104 can be a network firewall, network router, network monitoring component, a supervisory control and data acquisition (SCADA) component, or any other component. An example system architecture for a client device 104 is illustrated in greater detail in FIG. 5 and is described in detail below with reference to that figure.

The security network 106 can include one or more servers, server farms, hardware computing elements, virtualized computing elements, and/or other network computing elements that are remote from the client devices 104. In some examples, the security network 106 can be a cloud or a cloud computing environment. Client devices 104, and/or security agents 108 executing on such client devices 104, can communicate with elements of the security network 106 through the Internet or other types of network and/or data connections. In some examples, computing elements of the security network 106 can be operated by, or be associated with, an operator of a security service, while the client devices 104 can be associated with customers, subscribers, and/or other users of the security service.

As shown in FIG. 1, instances of the compute engine 102 can execute locally on client devices 104 as part of security agents 108 deployed as runtime executable applications that run locally on the client devices 104. Local instances of the compute engine 102 may execute in security agents 108 on a homogeneous or heterogeneous set of client devices 104. Similarly, instances of the predictions engine 114 can execute locally on client devices 104 as part of security agents 108 deployed as runtime executable applications that run locally on the client devices 104. Local instances of the predictions engine 114 may execute in security agents 108 on a homogeneous or heterogeneous set of client devices 104.

One or more cloud instances of the compute engine 102 can also execute on one or more computing elements of the security network 106, remote from client devices 104. The distributed security system 100 can also include a set of other cloud elements that execute on, and/or are stored in, one or more computing elements of the security network 106. For example, the cloud elements of the security network 106 can include a predictions engine 114 and a storage engine 122, as discussed further below.

Local and/or cloud instances of the compute engine 102, and/or other elements of the distributed security system 100 such as predictions engine 114, can process event data 118 about single events and/or patterns of events that occur on one or more client devices 104. Events can include any observable and/or detectable type of computing operation, networking operation, behavior, or other action that may occur on or in connection with one or more client devices 104. According to embodiments of the present disclosure, events can include events and behaviors particularly associated with file system operations, including creating, downloading, uploading, reading, writing (or otherwise modifying), copying, importing, or exporting a file, or parts thereof, or moving the location of a file either within a file directory structure or to another file directory structure on the same or different client device 104. By way of non-limiting examples, an event may be a process that created a file, wrote to the file, and saved the file on the client device 104, or opened an existing file, modified the existing file, and/or saved the existing file under the same or different name and/or with the same or different file extension on the client device 104 or on another client device 104. In some examples, events based on other such observable or detectable occurrences can be or include physical and/or hardware events. For instance, the event may be that a Universal Serial Bus (USB) memory stick or other USB device was inserted in, or removed from, a client device 104, particularly when the event occurs in conjunction with recent file system operations such as dragging and/or dropping files between the USB device and a permanent storage device or other drive unit of the client device 104.

Events that occur on or in connection with one or more client devices 104, such as file system operations involving one or more files, can be detected or observed by event detectors 116 of security agents 108 on those client devices 104. For example, a security agent 108 may execute at a kernel-level and/or as a driver such that the security agent 108 has visibility into operating system activities from which one or more event detectors 116 of the security agent 108 can observe event occurrences or derive or interpret the occurrences of events. In some examples, the security agent 108 may load at the kernel-level at boot time of the client device 104, before or during loading of an operating system, such that the security agent 108 includes kernel-mode components such as a kernel-mode event detector 116. In some examples, a security agent 108 can also, or alternately, have components that operate on a computing device in a user-mode, such as user-mode event detectors 116 that can detect or observe user actions and/or user-mode events.

When an event detector 116 of a security agent 108 detects or observes a behavior or other event that occurs on a client device 104, such as file system operations, the security agent 108 can place corresponding event data 118 about the event occurrence on a bus 112 or other memory location. For instance, in some examples the security agent 108 may have a local version of a storage engine 122 described herein below or have access to other local memory on the client device 104, where the security agent 108 can at least temporarily store event data 118. The event data 118 on the bus 112, or stored at another memory location, can be accessed by other elements of the security agent 108, including an instance of the compute engine 102, and/or a communication component 110 that can send the event data 118 to the security network 106, and/or an instance of predictions engine 114.

Each security agent 108 can have a unique identifier, such as an agent identifier (AID). Accordingly, distinct security agents 108 on different client devices 104 can be uniquely identified by other elements of the distributed security system 100 using an AID or other unique identifier, or a combination of an AID and another unique identifier, such as a client device identifier or network and/or IP address associated with the client device. In this manner, event data 118 and/or prediction results 120, for example, related to file system operations involving one or more files, can be associated with a particular client device and/or security agent.

In some examples, event data 118 about events detected or observed locally on a client device 104, such as file system operations involving one or more files or parts thereof, can be processed locally by a compute engine 102 and/or other elements of a local security agent 108 executing on that client device 104. However, in some examples, event data 118 about locally occurring events can also, or alternately, be sent by a security agent 108 on a client device 104 to the security network 106, such that the event data 118 can be processed by a cloud instance of the compute engine 102 and/or other cloud elements of the distributed security system 100, such as predictions engine 114. Accordingly, event data 118 about events that occur locally on client devices 104 can be processed locally by security agents 108, be processed remotely via cloud elements of the distributed security system 100 or be processed by both local security agents 108 and cloud elements of the distributed security system 100.

The storage engine 122 can process and/or manage event data 118 that is sent to the security network 106 by client devices 104, such as events related to file system operations involving one or more files or parts thereof. In some examples, the storage engine 122 can receive event data 118 from security agents 108 provided by an operator of a security service that also runs the security network 106. However, in other examples, the storage engine 122 can also receive and process event data 118 from any other source, including an instance of compute engine 102 executing in security network 106, an instance of the predictions engine 114 executing in security network 106, security agents 108 associated with other vendors or streams of event data 118 from other providers.

The storage engine 122 can operate on event data, such as event data related to file system operations involving one or more files or parts thereof. In particular, storage engine 122 can sort incoming event data 118, route event data 118 to corresponding instances of the compute engine 102, store event data 118 in short-term and/or long-term storage, output event data 118 to other elements of the distributed security system 100, such as instances of the predictions engine 114, and/or perform other types of storage operations.

A compute engine 102 in the distributed security system 100 can process an event stream of event data 118, such as event data related to file system operations involving one or more files or parts thereof. The event data 118 may have originated from an event detector 116 of a security agent 108 that initially detected or observed the occurrence of an event on a client device 104, and/or may be event data 118 that has been produced by a different instance of the compute engine 102. In a local instance of the compute engine 102 (i.e., an instance of compute engine 102 operating on a client device 104), in some examples the event stream may be received from a bus 112 or local memory on a client device 104. In a cloud instance of the compute engine 102, in some examples the event stream may be received via the storage engine 122.

The compute engine 102 can generate a result from event data 118 in an event stream, such as a result about event data related to file system operations involving one or more files or parts thereof. For example, if the event stream includes event data 118 indicating that one or more events occurred that match a behavior pattern, such as copying a file to a new location, performing a write operation on the copied file, and changing the name of the copied file, the compute engine 102 can generate and output a result indicating that there is a match with the behavior pattern. In some examples, the result can itself be new event data 118 specifying that a behavior pattern has been matched, and/or, for example, the result can be a feature vector associated with a file, as described further below. The generated results may be stored in storage engine 122, for example, for subsequent input to an instance of compute engine 102 or an instance of predictions engine 114.

According to embodiments of the present disclosure, an input event stream of event data 118, such as event data related to file system operations involving one or more files or parts thereof, can be sent to the security network 106 by one or more local security agents 108. Such an input event stream of event data 118 can be received by a storage engine 122 in the security network 106, as shown in FIG. 1. In some examples, security agents 108 can send event data 118 to the security network 106 over a temporary or persistent connection, and a termination service or process of the distributed security system 100 can provide event data 118 received from multiple security agents 108 to the storage engine 122 as an input event stream.

The event data 118 in the input event stream, such as event data related to file system operations involving one or more files or parts thereof, may be in a random or pseudo-random order when it is received by the storage engine 122 in the security network 106. For example, event data 118 for different events may arrive at the storage engine 122 in the input event stream in any order without regard for when the events occurred on client devices 104. As another example, event data 118 from security agents 108 on different client devices 104 may be mixed together within the input event stream when they are received at the storage engine 122, without being ordered by identifiers of the security agents 108. However, the storage engine 122 can perform various operations to sort, route, and/or store the event data 122 within the security network 106.

Digital security systems may find it challenging to process event data, such as event data related to file system operations involving one or more files or parts thereof, to accurately distinguish between legitimate or malicious or anomalous behavior in the event data, for example, because malware and threat actor behavior is rapidly changing. What is needed, and what is provided by the example embodiments described below, is an evaluation of event data to uncover new or previously unknown or undetected malicious or anomalous behavior. To that end, sensors, or security agents 108, on client computing devices 104 collect event data including event data related to file system operations involving one or more files or parts thereof and transmit that event data 118 to local instances of compute engine 102 and/or remote instances of compute engine 102 in security network 106. Once received at a compute engine, the event data can be manipulated to generate results, such as feature vectors, which can then be transmitted to local instances of predictions engine 114 and/or remote instances of predictions engine 114 in security network 106. The predictions engine 114 can process the results received from compute engine 102 and generate prediction results 120 about one or more source code programming languages in which source code is written in the one or more files.

The prediction results 120 can be transmitted back to selected client devices 104 where the predictions can inform practices and generation of threat detection rules logic on the client devices to more accurately counter or pre-empt the occurrence of new or repeated but previously undetected attacks or malicious or anomalous behavior.

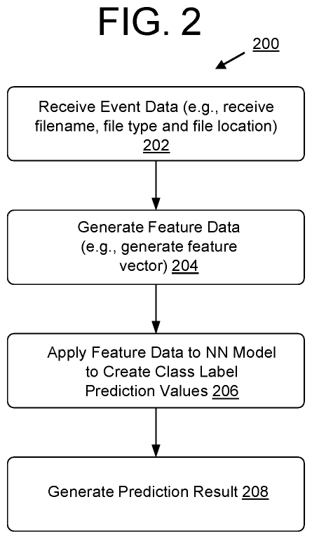

FIG. 2 is a flowchart 200 for predicting that a text file contains source code written in one or more source code programming languages. At block 202, a local instance of a compute engine 102 in a security agent 108 operating within a client device 104 can receive an event stream comprising event data 118 associated with an occurrence of one or more events on the client device 104 detected by event detector(s) 116. As an example, the compute engine may receive event data 118 related to file system operations on a drive unit of client device 104 involving one or more files or parts thereof stored in a file system resident on a drive unit of client device 104. In example embodiments, the compute engine 102 may receive as part of the event data 118 one or more of a name of a file, a type of the file, and a location of the file in a file directory on client device 104, and optionally on which a file system operation has been detected. A file system operation may include but is not limited to creating, downloading, uploading, reading, writing (or otherwise modifying), copying, importing, or exporting a file, or parts thereof, or moving the location of a file either within a file directory structure or to another file directory structure on the same or different client device 104. In other example embodiments, the event data may first be stored in a local instance of a storage engine 122 which can then process and/or manage the event data 118 that is sent to the compute engine 102. In some examples, the local instance of storage engine 122 can receive event data 118 from the security agent 108 provided by an operator of a security service that also runs the security network 106. However, in other examples, the local instance of storage engine 122 can receive and process the event data from a security agent 108 associated with other vendors or streams of event data 118 from other providers. In other example embodiments, the event data may be transmitted from a security agent 108 to security network 106, bypassing any local instances of storage device 122, wherein the event data may be first stored in a cloud instance of storage engine 122. In such case, the cloud instance of storage engine 122 can sort and route the event data to instances of the compute engine 102, store event data 118 in short-term and/or long-term storage, and output event data 118 to other elements of or in the distributed security system 100. In all these examples, a local- or cloud-instance of compute engine 102 eventually receives event data 118 and can then process and/or manage the event data at block 204, as described below.

Compute engine 102 can generate at block 204 feature data based on the received event data 118, for example, based on one or more of the received file name, file type, and file location. Alternatively, compute engine 102 can generate feature data without first receiving event data 118. For example, compute engine 102 could inspect one or more files in the file system on client device 104 on its own initiative, without ever relying on event detectors 116 to send event data 118, or without waiting for event detectors 116 to send event data 118. For example, the compute engine 102 could crawl or walk all or selected parts of the file system on a periodic basis or according to other criteria to inspect one or more files in the file system on client device 104. For example, the compute engine 102 may track when it last crawled or walked the file directory or a subdirectory in the file system and inspect files with a creation date or a modification date after the date that the compute engine 102 last crawled or walked the file system and generate at block 204 the feature data based on the inspection initiated by the compute engine 102. In either case, as an example, the compute engine 102 may locate a file based on the file location information and inspect the file type and/or inspect the contents of the file located at the file location. The compute engine 102, upon detecting the file contains text-based data whether by inspection of the file type, or the contents of the file, or both, can generate the feature data, e.g., a feature vector, based on the contents of the file.

According to embodiments of the present disclosure, the feature vector based on the contents of the text file comprises a plurality of values, wherein each value represents a corresponding piece of text from the file. According to embodiments of the present disclosure, a piece of text comprises a n-gram, where the n-gram is a contiguous sequence of n bytes or n characters in the text file. According to embodiments of the present disclosure, an n-gram is a bigram, also referred to as a diagram, where n=2. As an example, a feature vector based on the contents of a text file that includes the phrase “hello world” comprises the following array of byte bigrams: “he”, “el”, “ll”, “lo”, “o<space>”, “<space>w”, “wo”, “or”, “rl” and “ld”. Since the most common UTF-8 encoded characters are represented by a single byte, the byte bigram in such case can be considered a character bigram.

According to embodiments of the present disclosure, text files may be variable in length. Thus, embodiments may create a feature vector based on a fixed-length portion of the file, say, the first 10,000 bytes. According to some embodiments of the present disclosure, the compute engine 102 creating the feature vector comprising the plurality of values, wherein each value represents the corresponding piece of text found in the text file, involves creating the feature vector comprising a plurality of integer values, wherein each integer value represents a ranking of a frequency of occurrence of a corresponding piece of text found in the text file as measured across a plurality of sample text files. In one embodiment, the plurality of sample text files contain source code written in one or more of the source code programming languages.

Thus, continuing with the above example, the array of byte bigrams: “he”, “el”, “ll”, “lo”, “o<space>”, “<space>w”, “wo”, “or”, “rl” and “ld” obtained from the phrase “hello world” is converted, according to embodiment of the present disclosure, to an array of integer values where each integer value represents a ranking of a frequency of occurrence of the corresponding byte bigrams found in the text file as measured across a plurality of sample text files. For example, the portion of the array of byte bigrams “he”, “el”, . . . , “lo” is converted to the following portion of an array of integer values 12, 34 . . . 1031.

According to embodiments, a byte bigram lookup table is created and maintained that stores each byte bigram and a corresponding integer value that represents the ranking of the frequency of occurrence of the byte bigram as measured across a plurality of sample text files. If a byte bigram is not found in the byte bigram lookup table, a default integer value, for example, 0 (zero), is used to represent the byte bigram in the feature vector. If the number of bytes in a text file is less than the fixed-length portion, then the feature vector is padded with a default value, say, 0 (zero). For example, if a text file is only 5000 bytes in length, and the fixed-length portion used for the feature vector is defined as the first 10,000 bytes of a text file, then the feature vector for the text file is padded with 5000 zeros. Thus, it is a quick and relatively easy computational step to create the feature vector comprising the plurality of integer values, wherein each value represents a corresponding piece of text found in the text file. In this manner, embodiments of the present disclosure generate feature vectors of, say, 10,000 integer values for each text file that is inspected.

According to one embodiment, the byte bigram lookup table may be constructed by counting every unique byte bigram across a plurality (e.g., millions) of sample text files across a plurality of (e.g., 45) programming languages and creating a sorted ranked list based on the total byte bigram frequencies counts across the text files. According to one embodiment, the sorted ranked list may be limited to a portion of the most common byte bigrams. In testing embodiments of the present disclosure, for example, the list included the most frequent 21,883 byte bigrams. This number was chosen based on those byte bigrams having more than 50 frequency counts across the text files. According to embodiments, the rank of the byte bigram in the byte bigram lookup table is the integer value representation for that byte bigram. It is appreciated that other approaches, involving more advanced analysis, using techniques like term frequency inverse document frequency (TFIDF), may also be used. Doing so would likely change the size of and values in the byte bigram lookup table.

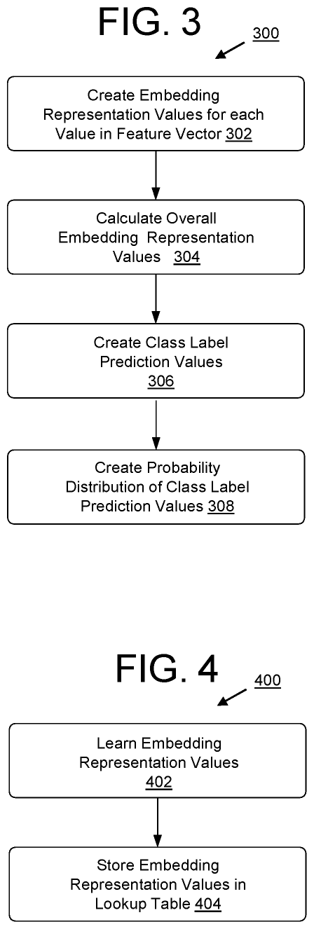

At block 206, the feature data 204 is passed from the compute engine 102 to the predictions engine 114 in the security agent 108 of client device 104. The predictions engine 114 receives the feature data 204, for example, a feature vector comprising a plurality of values, wherein each value represents a corresponding piece of text found in the text file. A flowchart 300 in FIG. 3 lists the steps performed by predictions engine 114. With reference to FIG. 3, the feature vector 204 is applied to the predictions engine 114 which obtains at step 302 an embedding representation value for each integer value in the feature vector. The embedding representation values are learned during a training workflow of the neural network model. According to certain embodiments of the present disclosure, these embedding representation values comprise 128 dimensional values, and so a 128×10,000 dimension matrix is created, for example, when the feature vector comprises 10,000 integer values.

According to embodiments of the present disclosure, this can be a very efficient operation by searching a single embedding layer. According to certain embodiments of the present disclosure, the embedding layer is implemented as an embedding representations lookup table. The embedding lookup table is searched for the embedding representation value corresponding to each integer value in the feature vector. The operation can be even more efficient by creating a hash map, in particular, a perfect hash map, of the embeddings representation lookup table. In such case, searching the embedding representations lookup table for the embedding representation value corresponding to each integer value in the feature vector involves performing a constant time lookup in the perfect hash map of the embedding representations lookup table for the embedding representation value corresponding to each integer value in the feature vector.

Furthermore, the strict memory footprint discussed above can be maintained by the predictions engine 114 executing the inference workflow of the neural network model using a compiled, strongly-typed computer programming language, such the Rust programming language, available under licenses from MIT and Apache 2.0. Rust, in particular, enforces memory safety. For example, all references point to valid memory. Thus, Rust does not require the use of a garbage collector or reference counting present in other memory-safe languages, so a strict memory footprint can be maintained.

Additionally, the execution time constraints discussed above can be maintained because the dense embeddings representations lookup table containing the embedding representation values corresponding to the integer values in the feature vector can be created during a training workflow of the neural network model. This can be accomplished before run time, for example, using one or more instances of the cloud-based predictions engine 114, rather than using the local predictions engine 114 in security agent 108 of client device 104.

The flowchart 400 in FIG. 4 lists the steps for the training workflow of the neural network model. In particular, with reference to FIG. 4, the cloud-based predictions engine, at step 402, can learn, during the training workflow of the neural network model, embedding representation values of pieces of text in a plurality of sample text files containing source code written in one or more of the plurality of source code programming languages, and, at step 404, store, for example, in storage engine 122, these embedding representation values in the embedding representations lookup table. In one embodiment, the embedding representation values are ordered in a perfect hash map of the embedding representations lookup table. The embedding representations lookup table can be copied from cloud-based storage engine 122 to the local storage engine 122 in security agent 108 of client device 104 so that it is later available for step 302 during runtime, that is, during execution of the inference workflow of the neural network model.

Returning to FIG. 3, at step 304, an overall or global embedding representation value for the feature vector is determined based on the embedding representation values for the respective values in the feature vector 204. Doing so allows the neural network model to handle input vectors of variable length in a straightforward manner. For example, predictions engine 114 calculates the overall embedding representation value for the feature vector by averaging the embedding representation values for the respective values in the feature vector 204. As mentioned previously, according to certain embodiments of the present disclosure, the embedding representation values comprise 128 dimensional values, and so a 128×10,000 dimension matrix is created, for example, if the feature vector comprises 10,000 integer values. Thus, step 304 reduces the 128×10,000 dimension matrix to a single 128 dimension matrix, according to these embodiments.

At step 306, predictions engine 114 creates a plurality of class label prediction values based on the overall embedding representation value and a plurality of class labels corresponding to the plurality of source code programming languages (i.e., class=programming language). According to embodiments of the present disclosure, the predictions engine 114 creating the plurality of class label prediction values based on the overall embedding representation value and the plurality of class labels corresponding to the plurality of source code programming languages involves performing, by a single fully connected softmax layer, a single matrix multiplication operation with the overall embedding representation value and the plurality of class labels corresponding to the plurality of source code programming languages.

The above describe method performed by the predictions engine 114 is very fast, not only because the predictions engine 114 uses a compiled, strongly-typed computer programming language, such as the Rust programming language, but because the neural network model, according to embodiments of the present disclosure is ‘shallow’, compared to a very ‘deep’ neural network model with a multiple hidden layers which would increase the required computation and would slow down the entire classification process. The neural network according to embodiments is ‘shallow’ because there is only a single hidden layer (softmax layer). The first embedding layer is created during training workflow of the neural network model. Accessing this first embedding layer during inference workflow of the neural network model merely involves a constant time lookup in the embedding representations lookup table—no matrix multiplication is required—so the process is, relatively speaking, very fast.

Finally, and optionally, at step 308, predictions engine 114 can, during or following the inference workflow of the neural network model, normalize the class label prediction values to create a probability distribution of class label prediction values, summing to a value of 1.

Returning to FIG. 2, at step 208, the predictions engine 114 produces a prediction result. For example, the predictions engine 114 predicts a source code programming language in which the source code is written in the text file based on the plurality of class label prediction values and/or based on the probability distribution of the plurality of class label prediction values. According to one embodiment of the present disclosure, predicting the source code programming language in which the source code is written in the text file based on the plurality of class label prediction values involves predicting the source code programming language corresponding to a highest class label prediction value among the plurality of class label prediction values. According to another embodiment of the present disclosure, predicting the source code programming language corresponding to the highest class label prediction value among the plurality of class label prediction values involves predicting the source code programming language corresponding to the highest class label prediction value that exceeds a minimum threshold value. In one embodiment, the class label prediction value with the maximum or highest probability distribution value is selected as the predicted class/source code programming language. A threshold value may optionally be configured for the probability distribution values of the class label prediction values so that if the highest probability distribution value is below the threshold value, the prediction result classifies the source code programming language in which the text in the text file is written as unknown.

The predictions engine 114 may transmit the prediction result to the client computing device 104, which, in turn, may transmit the prediction result to the security network 106. The security network 106, depending on a process ID, a client device 104 ID, a security agent 108 ID, or some combination thereof, can transmit the prediction result to a select one or more client devices 104. In some embodiments, the prediction result is transmitted to one or more client devices 104 depending on the prediction result and/or the likelihood that a copy of the text file associated with the prediction result may or will be present on one or more other client devices 104, so that those client devices may take appropriate action.

Client devices 104, upon receipt of a prediction result, can act on that information according to local business logic. For example, the client device 104 may generate behavior detection logic to be executed by one or more processors or security agents 108 on the client device 104, responsive to receiving the prediction result, for the purpose of increasing the digital data security on the client device 104.

FIG. 5 depicts an example system architecture 500 for a client device 104. A client device 104 can be one or more computing devices, such as a workstation, a personal computer (PC), a laptop computer, a tablet computer, a personal digital assistant (PDA), a cellular phone, a media center, an embedded system, a server or server farm, multiple distributed server farms, a mainframe, or any other type of computing device. As shown in FIG. 5, a client device 104 can include processor(s) 502, memory 504, communication interface(s) 506, output devices 508, input devices 510, and/or a drive unit 512 including a machine readable medium 514.

In various examples, the processor(s) 502 can be a central processing unit (CPU), a graphics processing unit (GPU), or both CPU and GPU, or any other type of processing unit. Each of the one or more processor(s) 502 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 502 may also be responsible for executing drivers and other computer-executable instructions for applications, routines, or processes stored in the memory 504, which can be associated with common types of volatile (RAM) and/or nonvolatile (ROM) memory.

In various examples, the memory 504 can include system memory, which may be volatile (such as RAM), non-volatile (such as ROM, flash memory, etc.) or some combination of the two. Memory 504 can further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information and which can be accessed by the client device 104. Any such non-transitory computer-readable media may be part of the client device 104.

The memory 504 can store data, including computer-executable instructions, for a security agent 108 as described herein. The memory 504 can further store event data 118, and/or other data being processed and/or used by one or more components of the security agent 108, including event detectors 116, a compute engine 102, and a communication component 110. The memory 504 can also store any other modules and data 516 that can be utilized by the client device 104 to perform or enable performing any action taken by the client device 104. For example, the modules and data can a platform, operating system, and/or applications, as well as data utilized by the platform, operating system, and/or applications.

The communication interfaces 506 can link the client device 104 to other elements through wired or wireless connections. For example, communication interfaces 506 can be wired networking interfaces, such as Ethernet interfaces or other wired data connections, or wireless data interfaces that include transceivers, modems, interfaces, antennas, and/or other components, such as a Wi-Fi interface. The communication interfaces 506 can include one or more modems, receivers, transmitters, antennas, interfaces, error correction units, symbol coders and decoders, processors, chips, application specific integrated circuits (ASICs), programmable circuit (e.g. field programmable gate arrays), software components, firmware components, and/or other components that enable the client device 104 to send and/or receive data, for example to exchange event data 118, and/or any other data with the security network 106.

The output devices 508 can include one or more types of output devices, such as speakers or a display, such as a liquid crystal display. Output devices 508 can also include ports for one or more peripheral devices, such as headphones, peripheral speakers, and/or a peripheral display. In some examples, a display can be a touch-sensitive display screen, which can also act as an input device 510.

The input devices 510 can include one or more types of input devices, such as a microphone, a keyboard or keypad, and/or a touch-sensitive display, such as the touch-sensitive display screen described above.

The drive unit 512 and machine readable medium 514 can store one or more sets of computer-executable instructions, such as software or firmware, that embodies any one or more of the methodologies or functions described herein. The computer-executable instructions can also reside, completely or at least partially, within the processor(s) 502, memory 504, and/or communication interface(s) 506 during execution thereof by the client device 104. The processor(s) 502 and the memory 504 can also constitute machine readable media 514.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 2-4. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

By the abovementioned technical solutions, the present disclosure provides a documentation generation engine coupled to a mutation handler configured to traverse a knowledge base to derive selective views. Organizations may configure a documentation generator application running on generator hosts to summarize records of a knowledge base storing institutional knowledge, and relationships there between, as a series of human-readable reference documents. However, it is undesired for the documentation generator to, whenever a change occurs at one or more records of the knowledge base, query the knowledge base on a naive basis in order to derive views required to generate updated documentation. Therefore, example embodiments of the present disclosure provide a query-writing framework which describes a schema organizing these records for human readability and describing relationships of these records to other records of interest, from which a set of queries may be derived which cause a knowledge base to return all records topically related by a schema of a query-writing framework, while minimizing excess querying which may unnecessarily amplify computational workload and network traffic.

Although the subject matter has been described m language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method to predict that a text file contains source code written in one or more of a plurality of source code programming languages, comprising:
creating a feature vector comprising a plurality of values, wherein each value represents a corresponding piece of text found in the text file;
during an inference workflow of a neural network model,
obtaining an embedding representation value for each value in the feature vector;
calculating an overall embedding representation value for the feature vector based on the obtained embedding representation values; and
creating a plurality of class label prediction values based on the overall embedding representation value and a plurality of class labels corresponding to the plurality of source code programming languages; and
predicting a source code programming language in which the source code is written in the text file based on the plurality of class label prediction values.

2. The method of claim 1, wherein creating a feature vector for the text file comprises creating a feature vector based on a portion of the text file.

3. The method of claim 1 wherein creating the feature vector comprising the plurality of values, wherein each value represents the corresponding piece of text found in the text file comprises creating the feature vector comprising a plurality of integer values, wherein each integer value represents a ranking of a frequency of occurrence of a corresponding piece of text found in the text file as measured across a plurality of sample text files containing source code written in one or more of the plurality of source code programming languages.

4. The method of claim 1, wherein the piece of text is a n-gram.

5. The method of claim 4, wherein the n-gram is a contiguous sequence of n bytes or n characters in the text file.

6. The method of claim 5, wherein the n-gram is a bigram.

7. The method of claim 1, wherein the inference workflow with the neural network model is executed by a compiled strongly-typed computer programming language.

8. The method of claim 1, wherein obtaining the embedding representation value for each value in the feature vector comprises searching an embedding representations lookup table for the embedding representation value corresponding to each value in the feature vector.

9. The method of claim 8, wherein searching the embedding representations lookup table for the embedding representation value corresponding to each value in the feature vector comprises performing a constant time lookup in a perfect hash map of the embedding representations lookup table for the embedding representation value corresponding to each value in the feature vector.

10. The method of claim 9, further comprising:
learning, during a training workflow of the neural network model, embedding representation values of pieces of text in a plurality of sample text files containing source code written in one or more of the plurality of source code programming languages; and
storing the embedding representation values, ordered in a perfect hash map of the embedding representations lookup table.

11. The method of claim 1, wherein calculating the overall embedding representation value for the feature vector based on the obtained embedding representation values comprises averaging the obtained embedding representation values.

12. The method of claim 1, wherein creating the plurality of class label prediction values based on the overall embedding representation value and the plurality of class labels corresponding to the plurality of source code programming languages comprises performing a single matrix multiplication operation with the overall embedding representation value and the plurality of class labels corresponding to the plurality of source code programming languages.

13. The method of claim 1 further comprising, during the inference workflow with the neural network model, creating a probability distribution of the plurality of class label prediction values.

14. The method of claim 1, wherein predicting the source code programming language in which the source code is written in the text file based on the plurality of class label prediction values comprises predicting the source code programming language corresponding to a highest class label prediction value among the plurality of class label prediction values.

15. The method of claim 14, wherein predicting the source code programming language corresponding to the highest class label prediction value among the plurality of class label prediction values comprises predicting the source code programming language corresponding to the highest class label prediction value that exceeds a threshold value.

16. A computer system, comprising:
one or more processors;
a memory to store computer-executable instructions that, when executed by the one or more processors, cause the one or more processors to perform operations comprising:
creating a feature vector comprising a plurality of values, wherein each value represents a corresponding piece of text found in the text file;
creating during an inference workflow of a neural network model a plurality of class label prediction values based on an embedding representation value representing the feature vector and a plurality of class labels corresponding to the plurality of source code programming languages; and
predicting a source code programming language in which the source code is written in the text file based on the plurality of class label prediction values.

17. The computer system of claim 16, wherein creating during an inference workflow of a neural network model a plurality of class label prediction values based on an embedding representation value representing the feature vector and a plurality of class labels corresponding to the plurality of source code programming languages comprises:
obtaining an embedding representation value for each value in the feature vector;
calculating an overall embedding representation value for the feature vector based on the obtained embedding representation values; and
creating a plurality of class label prediction values based on the overall embedding representation value and a plurality of class labels corresponding to the plurality of source code programming languages.

18. The computer system of claim 16, wherein the one or more processors execute the inference workflow of the neural network model using a compiled strongly-typed computer programming language.

19. One or more non-transitory computer-readable media storing computer-executable instructions that, when executed by one or more processors, cause the one or more processors to perform operations comprising:
creating a feature vector comprising a plurality of values, wherein each value represents a corresponding piece of text found in the text file;
creating during an inference workflow of a neural network model a plurality of class label prediction values based on an embedding representation value representing the feature vector and a plurality of class labels corresponding to the plurality of source code programming languages; and
predicting a source code programming language in which the source code is written in the text file based on the plurality of class label prediction values.

20. The one or more non-transitory computer-readable media of claim 19, wherein predicting the source code programming language in which the source code is written in the text file based on the plurality of class label prediction values comprises predicting the source code programming language corresponding to a highest class label prediction value among the plurality of class label prediction values.
